(19) United States
(12) Patent Application Publication
(10) Pub. No.: US 2006/0225536 A1
(43) Pub. Date: Oct. 12, 2006

(54) Bottle opener for pressurized bottles

(76) Inventor: Thomas Hill, Stillwater, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/100,220

(22) Filed: Apr. 6, 2005

(51) Int. Cl. B67B 7/00; B67B 7/18

(52) U.S. Cl. 81/3.36; 81/3.29

(57) ABSTRACT

An opener for pressurized bottle. The opener includes a sleeve having a first side and a second side. A bottle of pressurized liquid is capable of being located between the first side and the second side. The opener includes a main body and an elongated shaft terminating in a first end and a second end. The first end of the shaft is located in the main body. An arm extending from the second end of the shaft. A lifting mechanism is capable of moving the shaft into and out of the main body opening the bottle.

### FIELD OF THE INVENTION

The invention relates generally to the bottle openers. More specifically, the invention relates to a tool for gripping and removing champagne bottle stoppers quickly, easily, with less physical effort, and safely in such a way as to prevent the stopper from injuring anyone or damaging anything in the vicinity of the bottle.

### BACKGROUND OF THE INVENTION

Plastic champagne corks are machine inserted into glass bottlenecks very securely. Wire harnesses are also often attached to the corks and bottle necks so the bottles do not become opened during shipping and storage. This extreme pressure acting on the champagne cork can make opening a bottle quite a difficult procedure. Typically, the procedure for removing the stopper from a bottle of champagne is to remove the foil and the wire basket from around the bottle neck and then firmly grasp the stopper and force it out of the bottle with a twisting, turning or thrusting motion. Unfortunately, removing a stopper in this manner is quite difficult or even impossible for people with small hands or diminished gripping strength. More importantly, this stopper-removal procedure is also dangerous for the person removing the stopper and for any people or property nearby. At serving temperature, the pressure in a bottle of champagne can exceed ninety pounds per square inch. When a cork is dislodged from the bottle's neck it frequently bursts from the opener's grasp and flies erratically through the air due to the pressure in the bottle. In some instances the cork can strike and injure a person or damage property. There are numerous instances in which freed stoppers have knocked out front teeth, damaged eyes and gashed foreheads so deeply that stitches were required. Stoppers have also banged up furniture and become imbedded in ceiling tile.

The problem of opening champagne bottles has become so widespread that most bottles now contain a warning label outlining the associated dangers. In fact, some champagne makers have changed the configuration of the bottle neck and experimented with a variety of other such techniques in an attempt to reduce the dangers associated with removing the stopper. Unfortunately, these alterations have done little to reduce the danger since, no matter what the bottle configuration, the stopper is still under a great deal of pressure and thus can cause serious injury upon removal.

Not only have the difficulties in removing the stopper caused personal injury and property damage, they have also caused an increase in the price of champagne. Because opening a bottle of champagne can cause injury, champagne makers and the restaurants that serve it face increased liability, thus raising insurance premiums and, in turn, raising the cost to the consumer. In addition, manufacturing specialty bottles or stoppers is an expensive procedure, which again translates into higher prices to the consumer.

The use of corkscrews to remove the cork in a wine bottle is well known in the art, as is the use of a bottle opener to remove the cap on beer, and soft drinks. However, corkscrews and bottle openers are not effective for use in removing champagne stoppers.

U.S. Pat. No. 4,875,394, issued on Oct. 24, 1989, to C. B. Crudgington, Jr. describes a champagne bottle opener that includes bifurcated jaws for removing the mushroom-shaped stoppers from champagne bottles. Each jaw contains a recess so as to enable the device to be repositioned directly around the stopper's stem and on top of the bottle when the stopper has been partially removed. Clips are provided to the upper jaw so as to prevent the stopper from ricocheting out from under the retaining arm. The retaining arm permits a downwardly directed and manually exerted counter force to be applied to the stopper so as to allow the stopper to be removed slowly.

U.S. Pat. Nos. 4,583,652, 4,573,602, and 4,564,114 have issued to J. R. Goldberg concerning a molded safety closure device for champagne bottles. This device includes a cylindrical closure element which fits within the mouth of the bottle and which is restrained from flying free of the bottle by a cylindrical retainer collar which fits around the neck of the bottle. The closure element is attached to the collar by a tether strip which is molded integrally with the closure element and the collar and which tears free thereof. The closure element is molded as a separate unitary structure and is secured mechanically by a snap fit around the periphery of one end of the closure element.

U.S. Pat. No. 4,527,450, issued on Jul. 9, 1985, to B. J. Drosky teaches a stopper extractor that includes a housing having an open end and a closed end and a side-facing cutout on one side of the housing wall with a grip disposed for axial movement within the housing. The side-facing cutouts are sized to allow the enlarged head of a stopper to be inserted laterally into the grip. The extractor is mounted over the stopper with the open end against the container and the grip lip under the lower edge of the cork head. A rocking of the handle will pivot a cam so as to raise the grip. This causes the open end to bear downwardly against the container and the grip to move axially upwardly within the housing to pull the cork from the container and into the housing.

U.S. Pat. No. 4,513,870, issued on Apr. 30, 1985, to E. Zaltsman provides a bottle with a one-piece cork. This device employs a tether which is molded into the cork. When the cork is removed from the bottle, an energy-absorbing link serves to prevent the cork from flying away from the bottle at high speeds.

U.S. Pat. No. 4,442,735, issued on Apr. 17, 1984, to Chance et al. describes a safety device for preventing the premature expulsion of a stopper from a champagne bottle. A body is provided having a top and downwardly extending opposed leg portions attached to the top. Each of the leg portions has upper and lower inner ledge portions. The upper ledge portion is positioned for engagement with the lower rim surface of the stopper. The lower edge portion is positioned to provide a limit stop with the lower surface of the neck ridge upon upward motion of the device.

U.S. Pat. No. 4,018,110, issued on Apr. 19, 1977, to S. C. Spriggs shows a hand manipulable device for removing bottle stoppers. This device includes upper and lower bifurcated jaws engagable around the neck of a bottle between the shoulder and mouth of the bottle for engagement of the upper jaw below the overhanging stopper head whereby a spreading of the jaws effects an upward withdrawal of the stopper. A retaining arm is fixed to the upper jaw and extends generally centrally thereover in outwardly spaced relationship thereto. None of the prior art devices provide sufficiently protruding and sufficiently pointed long teeth separated by a sufficient distance with a sufficient indentation between the teeth to enable the teeth to straddle the ribs on a wire basket to permit the teeth to pierce through the foil and penetrate the stopper a sufficient distance for sure retention of the stopper afforded by such teeth in conjunction with a top guard.

Thus there is a clear need for an inventive new tool that will allow a person to quickly and safely remove the stopper from a bottle of champagne in a way that requires only minimal force from the user, thus making serving and drinking champagne a more enjoyable experience for everyone involved.

### SUMMARY OF THE INVENTION

In view of the shortcomings set forth above, it is an object of the invention to provide an opener for pressurized bottles that can be activated using single-hand operation. The invention includes a sleeve having a first side and a second side. A bottle of pressurized liquid is capable of being located between the first side and the second side. The opener includes a main body and an elongated shaft terminating in a first end and a second end. The first end of the shaft is located in the main body. An arm extending from the second end of the shaft. A lifting mechanism is capable of moving the shaft into and out of the main body.

In another embodiment, the invention includes a method for opening a bottle of pressurized liquid comprising the steps of disengaging the wire hood from the bottle; and removing the foil seal from the bottle. The method also includes the step of providing an opener including a sleeve having a first side and a second side, a main body; an elongated shaft terminating in a first end and a second end. The first end of the shaft is located in the main body. An arm extends from the second end of the shaft. The arm has a first fork and a second fork. A lifting mechanism is capable of moving the shaft into and out of the main body. The opener also includes an activating device such as a button, switch, lever, or similar component for starting or activating the lifting mechanism. The opener is positioned adjacent to the bottle such that the bottle is located between the first side of the sleeve and the second side of the sleeve. Next, the arm is aligned so that the cork is located between the first fork and the second fork, beneath the top section of the cork. A user then grasps the neck of the bottle and the body of the opener with a single hand and manipulates an activating device. The step of manipulating the activating device removes the cork from the bottle.

In yet another embodiment, the invention includes an opener comprising a sleeve including a ring, a main body, an elongated shaft terminating in a first end and a second end, wherein the first end of the shaft is at least partially disposed in the main body, an arm extending from the second end of the shaft, and a lifting mechanism capable of moving the shaft into and out of the main body.

### BRIEF DESCRIPTION OF THE DRAWINGS

The invention may be more completely understood in consideration of the following detailed description of various embodiments of the invention in connection with the accompanying drawings, in which:

FIG. 1 shows a left side view of a bottle opener engaging a sealed bottle pursuant to the invention.

FIG. 2 shows a front view of a bottle opener engaging a sealed bottle pursuant to the invention.

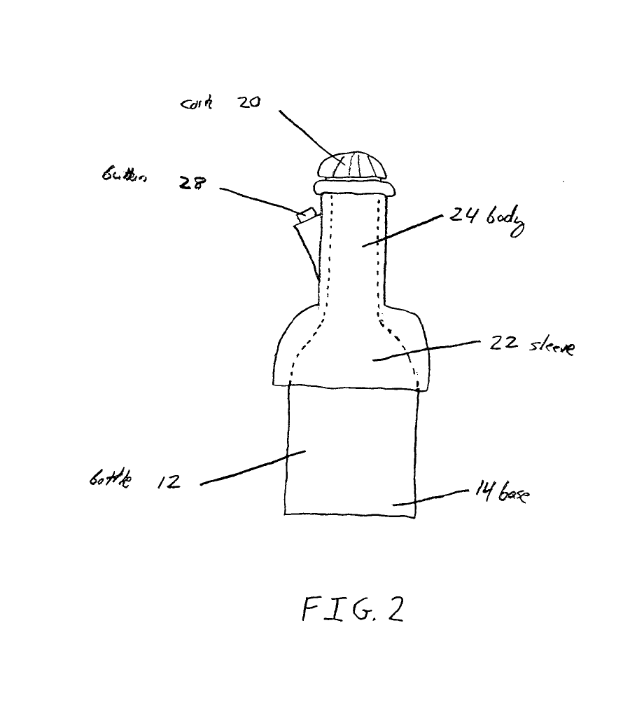

FIG. 3 shows a reverse front view of a bottle opener engaging a sealed bottle pursuant to the invention.

FIG. 4 shows a top view of a bottle opener engaging a sealed bottle pursuant to the invention.

FIG. 5 shows a side view of a bottle opener in a first position.

FIG. 6 shows a side view of a bottle opener in an expanded position.

FIG. 7 shows a side view of a bottle opener engaging a bottle in an expanded position.

FIG. 8 shows a side view of an alternative embodiment of a bottle opener engaging a bottle in an expanded position.

FIG. 9 shows a partial cross sectional view of the bottle opener.

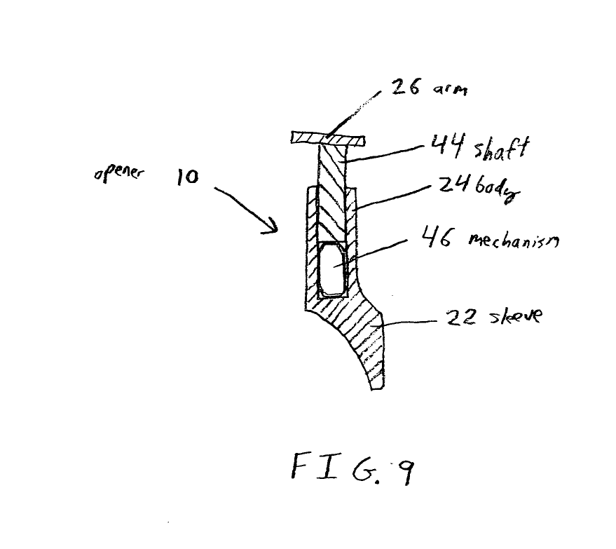

FIG. 10 shows a side view of an alternative embodiment of the bottle opener engaging a traditional wine bottle.

FIG. 11 shows a back view of an alternative embodiment of the bottle opener with integrated arm covers.

FIG. 12 shows a side view of an alternative embodiment of the bottle opener with manual lifting mechanism and irregular support.

FIG. 13 shows an alternative embodiment of the bottle opener with ring-shaped base.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

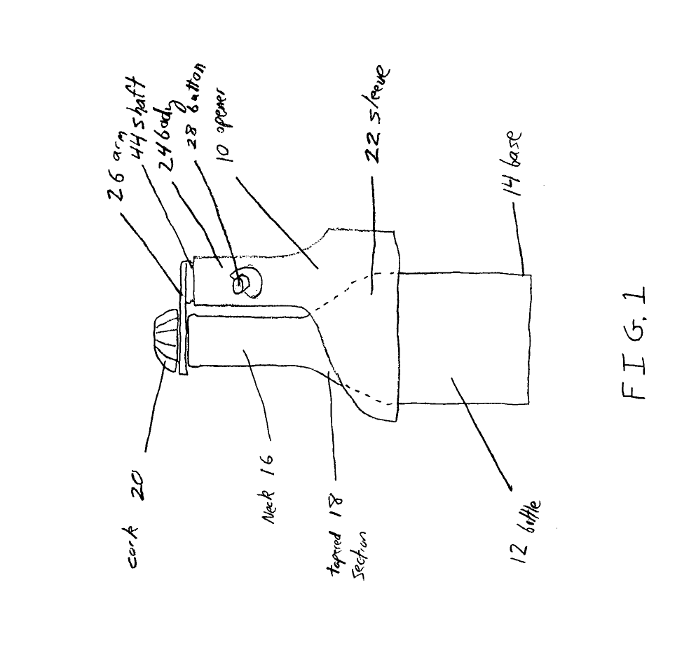

FIG. 1 shows an opener 10 for a pressurized bottle 12. The bottle 12 is a standard 750 ml champagne bottle, which includes a base 14, a neck 16, and a tapered region 18, extending from the base section 14 to the neck section 16. A cork 20 is at least partially disposed inside the neck section 16 to serve as a closure for bottle 12.

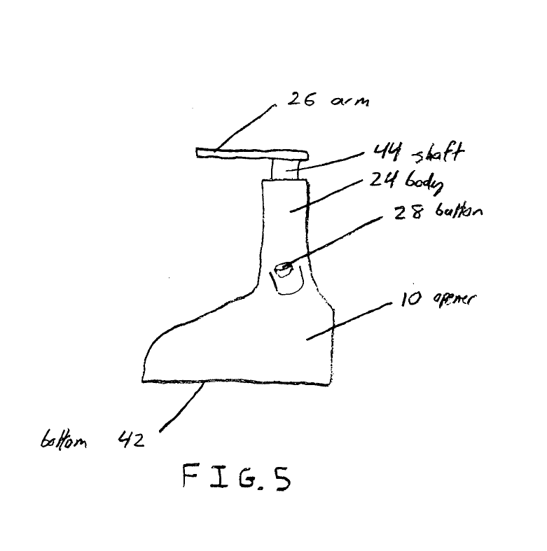

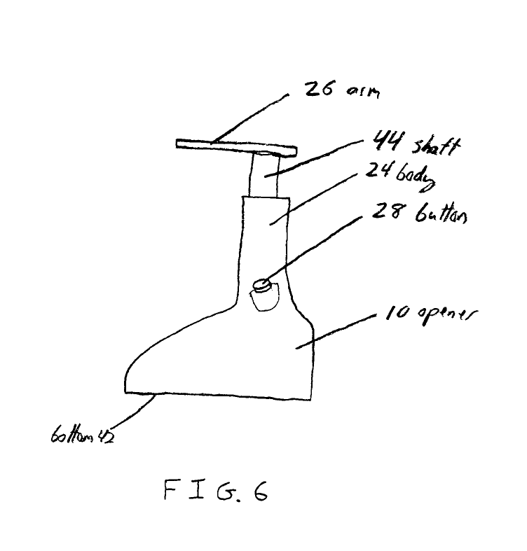

Opener 10 includes a sleeve 22, a body 24, and arm 26. Arm 26 extends from shaft 44 at between about a 45 degree angle and about a 135 degree angle, preferably about a 90 degree angle toward bottle 12. Button or switch 28 extends from the side of body 24 as shown in FIGS. 5 and 6.

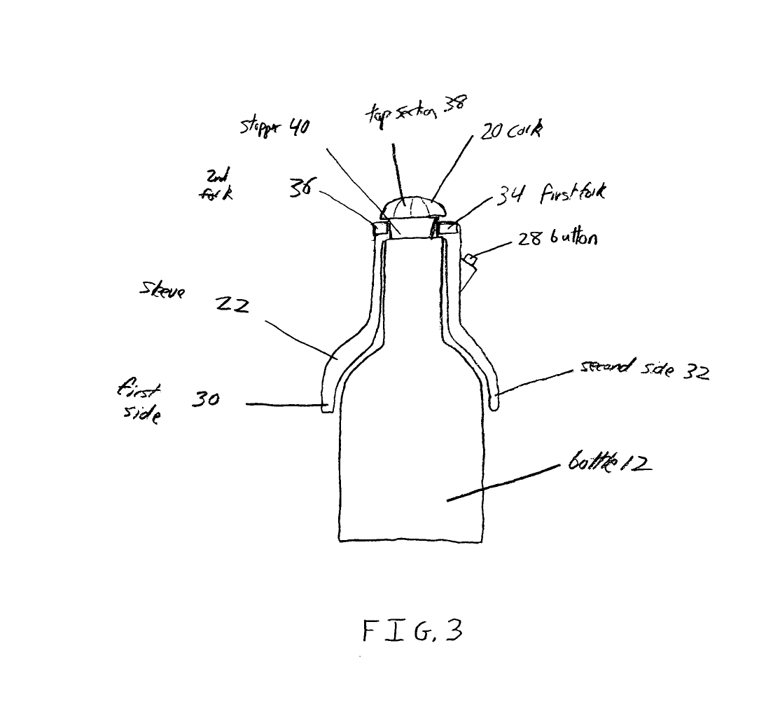

With reference to FIG. 3, sleeve 22 includes a first side 30 and a second side 32. In operation, bottle 12 is positioned between first side 30 and second side 32 so that at least a portion of sleeve 22 rests against tapered section 18 of bottle 22.

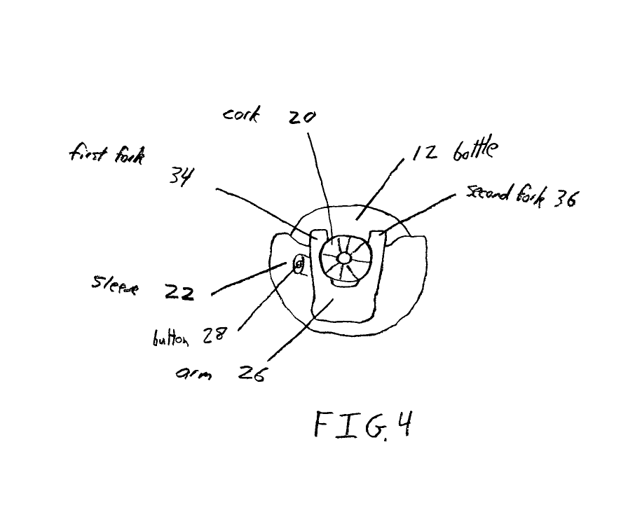

With reference to FIG. 4, additional details of arm 26 are shown. Arm 26 includes a first fork 34 and a second fork 36. Arm 26 can comprise a “V,” “U,” “Y”, or other snap-on configuration while remaining within the scope of the invention. Arm 26 preferably snaps or slides between neck 16 and top section 38 to engage cork 20. Opener 10 is positioned adjacent to bottle 12 so that cork 20 is at least partially disposed between first fork 34 and second fork 36. Similarly, first fork 34 and second fork 36 are located adjacent to stopper 40 of cork 20, between the neck 16 of bottle 12 and top section 38 of cork 20.

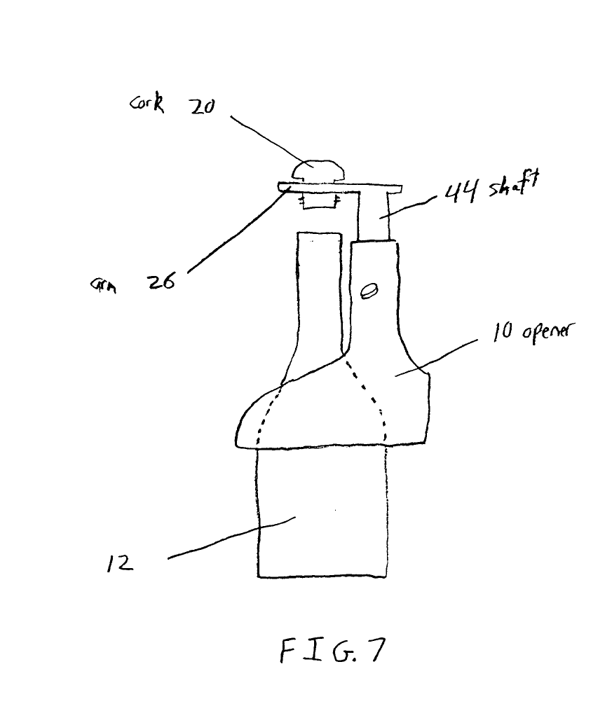

With reference to FIGS. 5-7, the operation of opener 10 will now be discussed. The distance between bottom 42 of opener 10 can be adjusted using button or switch 28. For example, when button or switch 28 is pressed, shaft 44 moves outwardly from body 24. In doing so, arm 26 moves away from bottom 42 from the position shown in FIG. 5 to the position shown in FIG. 6. When uncorking a bottle of pressurized liquid, such as champagne or sparkling wine, a user simply removes any foil or wire from the cork 20 and neck 16 of the bottle 12. Next, the user positions opener 10 adjacent to bottle 12 such that sleeve 22 rests on tapered section 18 of bottle 12. Then, first fork 34 and second fork 36 are positioned on opposite sides of stopper 40 of cork 20, between the neck 16 of bottle 12 and top section 38 of cork 20.

Once opener 10 is positioned against bottle 12 as described above, a user grasps his or her hand around the body 24 of opener 10 and the neck 16 of bottle 12. Next, the user presses button or switch 28 with his or her thumb. Pressing button or switch 28 causes lifting mechanism 46 to move shaft 44 outward from body 24. This action increases the distance between arm 26 and bottom 42 of opener 10.

As the distance between arm 26 and bottom 42 is increased, sleeve 22 firmly contacts tapered section 18 of bottle 12. At the same time, first fork 34 and second fork 36 of arm 26 come in contact with the under side of top section 38 of cork 20. As opener 10 increases pressure, stopper 40 of cork 20 lifts out of the neck 16 of bottle 12.

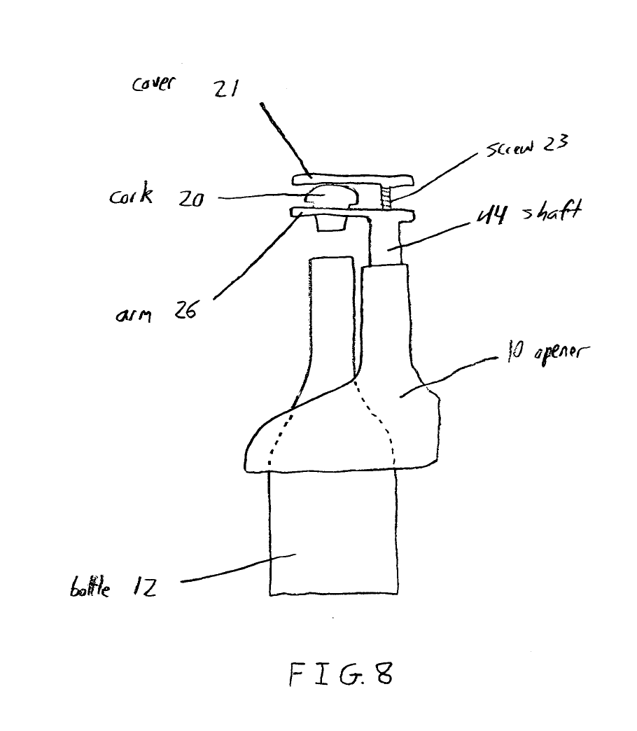

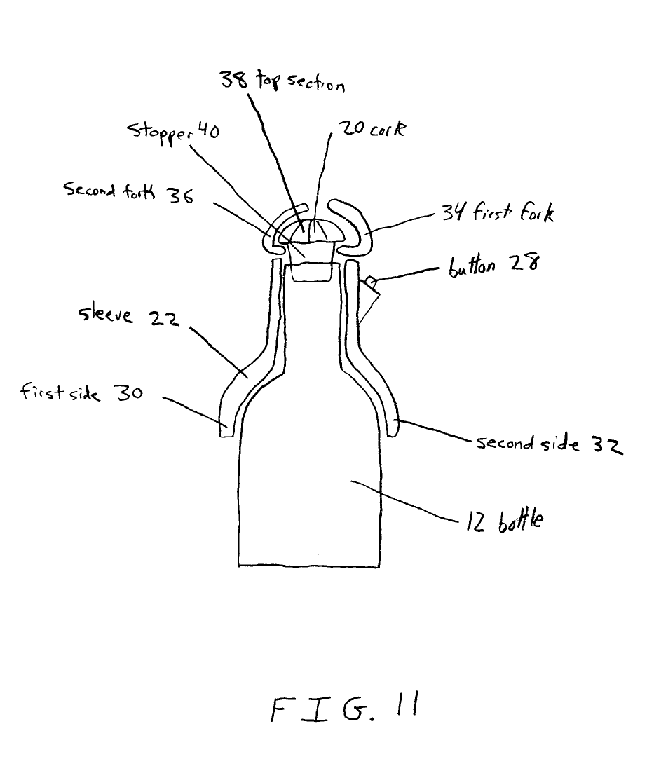

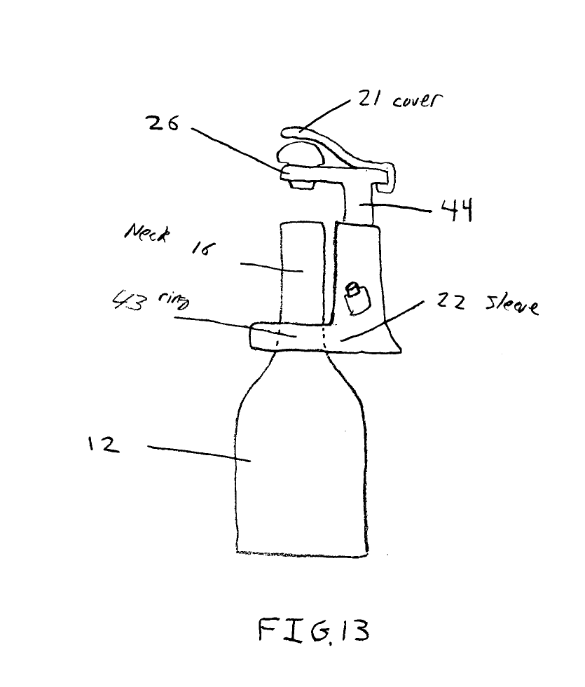

In many circumstances, the friction of arm 26 against stopper 40 under top section 38 of cork 20 prevents cork from flying outward from bottle 12 in the form of a projectile. However, in some circumstances, it is desirable to add an additional feature to control the movement of cork 20. With reference to FIG. 8, a cover 21 is located atop cork 20 such that top section 38 of cork 20 is located between arm 26 and cover 21. Cover 21 is connected to shaft 44 via screw 23. In an alternative embodiment, arms 34 and 36 have turned up sides that are disposed at least partially over top section 38 as shown in FIG. 11. The distance between cover 21 and arm 26 can be adjusted by rotating screw 23 further into shaft 44. In yet another alternative embodiment, cover 21 engages arm 26 by sliding or snapping on arm as shown in FIG. 13.

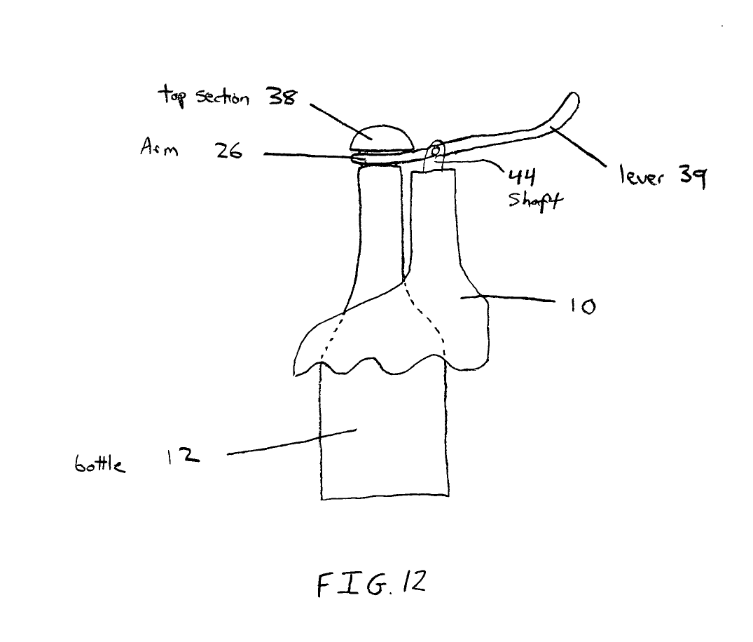

Lifting mechanism 46 can comprise a number of devices while remaining within the scope of the invention. Suitable mechanisms 46 can include commonly known electronic actuators, small motors, pneumatic, air, or hydraulic driven devices. Manual levers can also be used as shown in FIG. 12. Mechanism 46 should be small enough to fit inside body 24 and should generate a force sufficient to remove cork 20 from bottle 12.

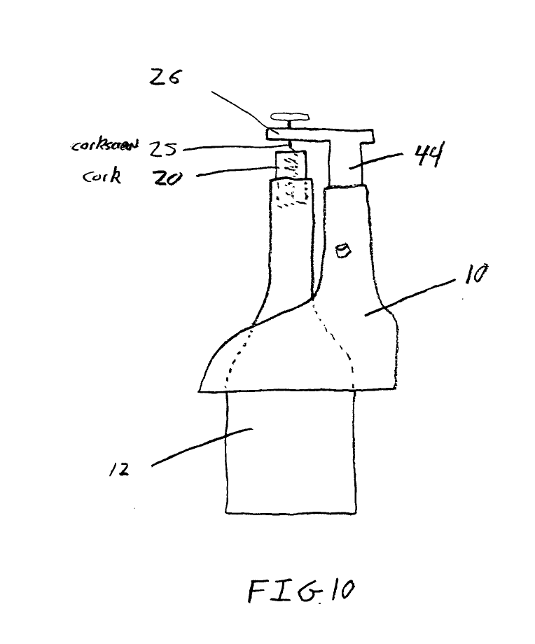

Opener 10 is suitable for removing traditional wooden corks from bottle 12 as well as synthetic, rubber, or plastic corks. As shown in FIG. 10, corkscrew 25 may be attached to arm 26 to permit the removal of traditionally shaped wine corks from bottle 12.

In a preferred embodiment, the interior of sleeve 22 is comprised of a soft material like an elastomer, felt, or other polymer. Moreover, bottom 42 of opener 10 is relatively flat to permit opener to stand upright on a bar or shelf. This feature of the invention can also be accomplished with a variety of irregular shapes, as shown, for example in FIG. 12. This aspect of the invention enables opener 10 to maintain an organized configuration.

Sleeve 22, arm 26, shaft 44, and body 24 of opener are preferably fabricated of a metal, or polymer of sufficient rigidity to withstand the downward pressure of opener 10 when cork 20 is removed from bottle. Moreover, the opener 10 is configured to be relatively lightweight, enabling the average user to lift the opener 10 and bottle 12 with a single hand. In one embodiment, opener 10 weighs less than about 10 pounds, preferably less than 5 pounds, more preferably, less than 3 pounds.

FIG. 13 shows yet another alternative embodiment of the invention. Sleeve 22 comprises a ring 43 containing an aperture. The neck 16 of bottle 12 is disposed through the aperture. Ring 43 is disposed about the circumference of neck 16 of bottle 12. Ring 43 applies pressure against the tapered section 18 of bottle 12 while remaining within the scope of the invention. Ring 43 can comprise a variety of sizes while remaining within the scope of the invention. Alternatively, a plurality of rings 43 may be disposed about the circumference of neck 16 of bottle 12. In yet another alternative embodiment, downward pressure could tighten a chain or cable around neck 16 to hold ring 43 against neck 16 while shaft 44 applies an upward force against cork 20. In a preferred embodiment, ring 43 is made of hard plastic, metals, chains, or cables.

Although the invention has been described with reference to preferred embodiments, workers of ordinary skill will recognize that changes can be made in form and detail without departing from the spirit and scope of the invention.

What is claimed is:

1. An opener comprising:
a sleeve including a first side and a second side, wherein a bottle of pressurized liquid is capable of being located between the first side and the second side;
a main body;
an elongated shaft terminating in a first end and a second end, wherein the first end of the shaft is located in the main body;
an arm extending from the second end of the shaft; and
a lifting mechanism capable of moving the shaft into and out of the main body.

2. The opener of claim 1, wherein the arm comprises a first fork and a second fork, wherein a champagne cork is capable of being disposed between the first fork and the second fork.

3. The opener of claim 2, wherein an activating device is disposed through the main body, wherein the activating device is capable of activating the lifting mechanism.

4. The opener of claim 3, further comprising an irregularly shaped bottom that enables the opener to rest in a general upright position.

5. The opener of claim 3, further comprising a substantially flat bottom.

6. The opener of claim 4, wherein a cover is attached to the arm.

7. The opener of claim 4, wherein the cover is integral with the arm.

8. The opener of claim 4, wherein the cover is configured to engage the arm.

9. The opener of claim 4, wherein a corkscrew is attached to the arm.

10. A method for opening a bottle of pressurized liquid comprising the steps of:
removing the foil seal from the bottle;
disengaging the wire hood from the bottle;
providing an opener including:
a sleeve including a first side and a second side,
a main body;
an elongated shaft terminating in a first end and a second end, wherein the first end of the shaft is located in the main body;
an arm extending from the second end of the shaft, the arm having a first fork and a second fork;
a lifting mechanism capable of moving the shaft into and out of the main body;
an activating device for activating the lifting mechanism;
positioning the opener adjacent to the bottle such that the bottle is located between the first side of the sleeve and the second side of the sleeve;
aligning the arm so that the cork is located between the first fork and the second fork, beneath the top section of the cork;
grasping the neck of the bottle and the body of the opener with a single hand;
manipulating the activating device, wherein the step of manipulating the activating device removes the cork from the bottle.

11. The method of claim 10, further comprising the step of removing the opener from the bottle.

12. The method of claim 11, further comprising the step of placing the opener on a surface, so that opener rests on the first side and the second side of the sleeve in an upright manner.

13. The method of claim 10, wherein the step of manipulating the activating device is effectuated using the thumb of said single hand.

14. An opener comprising:
a sleeve including a ring;
a main body;
an elongated shaft terminating in a first end and a second end, wherein the first end of the shaft is at least partially disposed in the main body;
an arm extending from the second end of the shaft; and
a lifting mechanism capable of moving the shaft into and out of the main body.

15. The opener of claim 14, wherein the lifting mechanism includes an electric actuator.

16. The opener of claim 14, wherein the lifting mechanism includes a hydraulic pump.

17. The opener of claim 14, wherein the lifting mechanism includes pressurized fluid.

18. The opener of claim 17, wherein the pressurized fluid is a gas.

19. The opener of claim 14, wherein the lifting mechanism includes an electric motor.

20. The opener of claim 14, wherein the lifting mechanism includes a manually operated lever.
